(19) United States
(12) Patent Application Publication
(10) Pub. No.: US 2026/0194173 A1
(43) Pub. Date: Jul. 9, 2026

(54) Multi-connection device with frontal coupling plates for simultaneous coupling of two or more hydraulic and/or electric lines

(71) Applicant: Faster S.r.l, Rivolta D'Adda (CR) (IT)

(72) Inventors: Roberto Sorbi, Rivolta D'Adda (CR) (IT); Alessandro Danelli, Brignano Gera D'Adda (BG) (IT)

(21) Appl. No.: 19/131,844

(22) PCT Filed: Nov. 22, 2023
(86) PCT No.: PCT/IB2023/061794

§ 371 Date: May 21, 2025

(30) Foreign Application Priority Data
Nov. 25, 2022 (IT) 102022000024333

(51) Int. Cl. F16L 37/56; F16L 37/20; H01R 13/00; H01R 13/629

(52) U.S. Cl. CPC F16L 37/56; F16L 37/20; H01R 13/005; H01R 13/62933; F16L 2201/10

(57) ABSTRACT

A device for the simultaneous connection of hydraulic lines and/or electrical connectors includes a fixed part and a movable part. The fixed part includes a fixed plate housing female quick couplings and/or electrical connectors, a connecting lever group, and a pair of vertical tie-rods slidably associated to the fixed plate and moved by the lever group due to connecting rods linked thereto. The tie-rods have a C-shaped portion, configured to slidably receive a movable plate of the movable part that supports male quick couplings and/or electrical connectors, whereby the movement of the lever group between an open and a closed position causes, due to the connecting rods, the vertical movement of the tie-rods, so that the movable plate is clamped on the fixed plate and the quick couplings and/or the female electrical connectors move from a disconnected condition to a connected condition.

### FIELD OF THE INVENTION

The present invention concerns a multi-connection device of the type with frontal coupling plates supporting a plurality of quick couplings, male and female, for the connection of hydraulic lines and/or a plurality of electrical connectors for the connection of electrical lines.

The multi-connection device according to the present invention provides an innovative system of levers that allows to reduce the overall encumbrance compared to the multi-connection systems of known type.

In addition, the multi-connection device with frontal coupling according to the present invention allows to have a precise and simple coupling between the plates without the need to have to provide for the presence of plugs and corresponding holes on the opposed plates to ensure the alignment thereof during the connection step. This allows to further compact the device as the entire surface of the plates can be used for positioning the couplings and/or connectors.

### STATE OF THE ART

It is known in the state of the art to make the connection of a plurality of hydraulic lines for oleodynamic applications and/or of electrical lines by means of multi-connection plate devices, in which a fixed plate is generally connected to the vehicle and supports a plurality of female couplings and/or female connectors, and a movable plate is generally connected to the user and supports a corresponding plurality of male quick couplings and/or male electrical connectors.

The connection of the movable plate to the fixed plate takes place by means of a lever coupling system that rotatably moves a pair of guide cams within which pins or rollers associated with the movable plate can be slidably engaged, so that by moving the lever to be closed, the approach and the clamping of the movable plate on the fixed plate is obtained. In the known systems, the presence of guide plugs and of corresponding holes for receiving said plugs on the opposed plates ensures the alignment between the couplings and/or the male and female connectors, so that by coupling the plates the connection of the couplings and/or the connectors is obtained at the same time.

Known solutions are described for example in EP 3 569 911 A1 on behalf of the same Applicant, as well as in US 2021/062949 A1, in US 2011/272937 A1 and DE 202010014532 U1 which provide examples in which the couplings are coupled with a substantially vertical reciprocal movement of the plates supporting the couplings or of the couplings themselves.

These solutions of known type suffer from some drawbacks.

These drawbacks include the dimensions of the coupling lever and of the plate-shaped elements that are part of the lever system and in which the grooves for the sliding of the rollers are obtained. The wide dimensions of the coupling lever are a consequence of both the need to reduce the connection effort necessary to couple the two plates, and the need to resist the separation forces caused by the hydraulic pressure affecting the lines and, therefore, the couplings.

A further drawback that afflicts the systems of known type consists in the encumbrance of plugs and guide holes necessary to align and guide the plates during the coupling step and which subtract space from the hydraulic couplings and/or the electrical connectors, making it necessary to have larger-sized plates to contain the same number of couplings/connectors.

These drawbacks are perceived negatively by the user, who requires where possible devices of reduced dimensions and weights.

### SUMMARY OF THE INVENTION

In light of the above, the task of the present invention is to provide a compact multi-connection device with frontal coupling plates supporting a plurality of quick couplings, male and female, for the simultaneous connection of a plurality of hydraulic lines and/or electrical connectors that allows to solve the inconveniences left unresolved by the state of the art.

Within this task, the object of the present invention is to provide a compact device for the simultaneous connection of a plurality of hydraulic lines and/or electrical connectors that has reduced dimensions compared to an equivalent device of known type, with the same couplings.

Still, an object of the present invention is to provide a compact device for the simultaneous connection of a plurality of hydraulic lines and/or electrical connectors incorporating a closing and protection system of the fixed plate.

The task set out above, as well as the aforementioned objects and others that will become clearer later, are achieved by a compact frontal connection plate device for the simultaneous connection of a plurality of hydraulic lines and/or electrical connectors according to the appended claim 1.

Other characteristics of the compact frontal connection plate device for the simultaneous connection of a plurality of hydraulic lines and/or electrical connectors according to the present invention are indicated in the dependent claims, which also form an integral part of the present description.

### LIST OF FIGURES

Further characteristics and advantages of the present invention will become clearer from the description of a preferred, but not exclusive, embodiment of the compact frontal connection plate device for the simultaneous connection of a plurality of hydraulic lines and/or electrical connectors according to the present invention, illustrated by way of example and not limitation with the aid of the accompanying drawings in which:

FIG. 1 shows a perspective view of the assembly of the device according to the present invention in a condition of connected plates and with lever in closed position;

FIG. 2 shows a perspective view of the fixed plate of the device according to the present invention in a disconnected condition with lever in closed position and lid closed;

FIG. 3 shows a perspective view of the fixed plate of FIG. 2 in a lever condition in a fully open position and lid in a partially open condition;

FIGS. 4 and 5 each show a partial sectional side view of the lever condition in the intermediate position of FIG. 3;

FIG. 6 shows a partial sectional view of the lever condition in the open position of FIG. 3 in which it is possible to appreciate the spring that leads the lid to the closed position;

FIG. 7 shows a partial sectional view of the lever condition in the open position of FIG. 3 in which it is possible to appreciate the action of the plugs that move the lid to be opened;

FIG. 8 illustrates a perspective assembly view of the movable plate of the device according to the present invention;

FIG. 9 illustrates the subsequent connection step in which the movable plate is brought closer to the fixed plate by positioning it between the tie-rods with a sliding movement;

FIG. 10 illustrates a partial sectional view with a vertical plane of the view of FIG. 9 in which the reciprocal positioning of the movable plate and of the closing lid can be noted;

FIG. 11 illustrates a subsequent connection step in which the movable plate is completely inserted into the grooves present in the tie-rods, although the lever is still in the open position corresponding to an unclamped plate condition;

FIGS. 12 and 13 each illustrate a partial sectional side view of the coupling condition of FIG. 11;

FIG. 14 illustrates a partial sectional side view of a condition in which the lever is lowered and the plates coupled.

### DETAILED DESCRIPTION OF THE INVENTION

With particular reference to the attached figures, the compact frontal connection plate device 100 for the simultaneous connection of a plurality of hydraulic lines and/or electrical connectors according to the present invention comprises a fixed part 10 and a movable part 20.

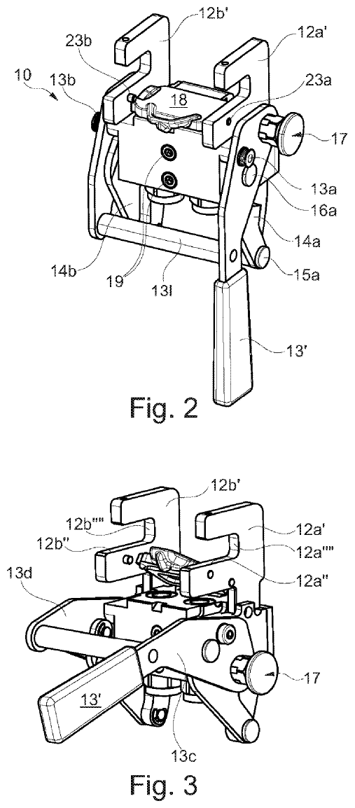

The fixed part 10 comprises the assembly visible in FIG. 2 comprising not only the fixed plate 11 within which the female couplings 11′are housed, but also the connection lever group 13, the protection lid 18 of the fixed plate 11 and a pair of vertical tie-rods 12a, 12b slidably associated vertically with said fixed plate 11 and moved by said lever group 13 by means of connecting rods 14a, 14b.

More in detail, with reference to FIGS. 2 and 3, the fixed part 10 comprises a fixed plate 11 within which a plurality of female couplings 11′ is housed and on which the lever group 13 is hinged.

The lever group 13 comprises in turn the handle 13′ apt to be gripped by the operator for the movement of the lever group itself, and a pair of shaped plates 13c, 13d which are pivoted to the opposite sides of said fixed plate 11 at a pair of first coaxial pins 13a, 13b.

In order to stiffen the lever group 13 and to make it possible to use a single handle 13′, a connection element 131, constituted in the example shown in the figures by a cylindrical bar 131, connects together said shaped plates 13c and 13d.

Said lever group 13 further comprises said pair of connecting rods 14a, 14b, placed on the sides of said lower fixed plate 11, pivoted respectively to one of said vertical tie-rods 12a, 12b at second hinge pins 15a, 15b, and to said shaped plates 13c, 13d at third hinge pins 16a, 16b.

The configuration and the operation of the lever group 13 and of the connecting rods 14a, 14b is visible in particular in Figures from 2 to 7: FIG. 2 shows the lever group 13 in the lowered connection position, and as can be noted it corresponds to a lowered position of the tie-rods 12a, 12b; FIG. 3 shows how by moving the lever group 13 to the raised disconnection position, also the tie-rods 12a, 12b are pushed upwards by the action of the connecting rods 14a, 14b.

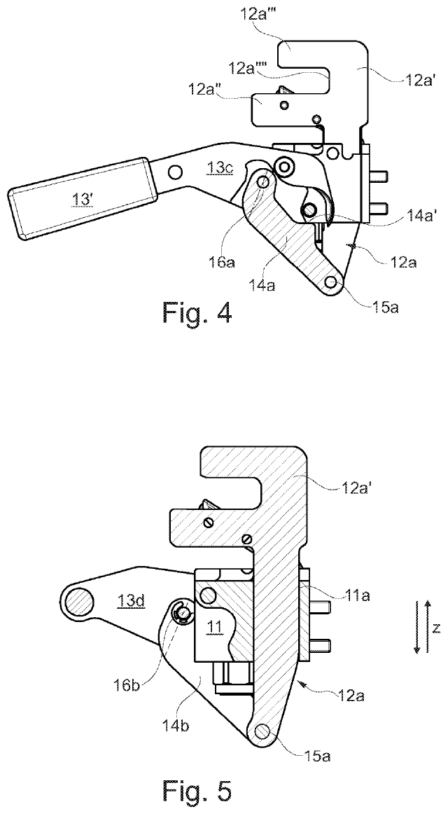

FIGS. 4 and 5 allow to appreciate the configuration of the connecting rods 14a, 14b and of the tie-rods 12a, 12b, which end above said fixed plate 11 with a C-shaped portion 12a′, 12b′, comprising a lower arm 12a″, 12b″ an upper arm 12a″′, 12b″′ and a substantially vertical connecting element 12a″″, 12b″″.

The movement of the lever group 13 causes the movement of the connecting rods 14a, 14b and of the tie-rods 12a, 12b which translate in vertical direction.

As is visible in particular in FIGS. 2, 3, 6 and 7, on the fixed plate 10 there is provided a closing lid 18 apt to protect the upper surface of the fixed plate 11, in which the female couplings 11′ are housed, from dirt and dust.

Advantageously, on the lever group 13 there is a safety system 17, comprising according to what is known from the state of the art a lock in turn comprising an abutment plug apt to fit into a special receiving hole obtained on the plate apt to lock the movement of the lever.

The multi-connection fixed part 10 can preferably be fixed to the operating machine by means of two screws 19 placed in the frontal position and therefore easily accessible.

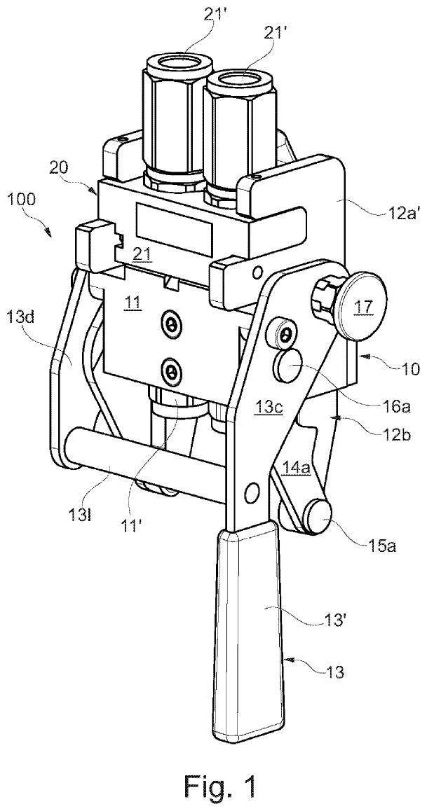

With particular reference to FIG. 1, a first connection step provides for the operator to act on the lock 17 by operating it in order to be able to subsequently rotate the lever group 13 by acting on the handle 13′.

The lock 17 could be either of the push type or of the pull type, so in order to be able to operate it, the operator may have to push or pull outwards the safety button.

FIG. 3 illustrates the lever group 13 rotated into the “open” position corresponding to a disconnection condition. The centre of rotation of the lever consists of the first pins 13a, 13b, advantageously consisting of screws screwed in the fixed plate 11.

As already mentioned, the connecting rods 14a, 14b are connected to the lever 13 through the pins 16a, 16b, therefore the rotation of the lever 13 also generates a displacement of the aforementioned connecting rods 14a, 14b.

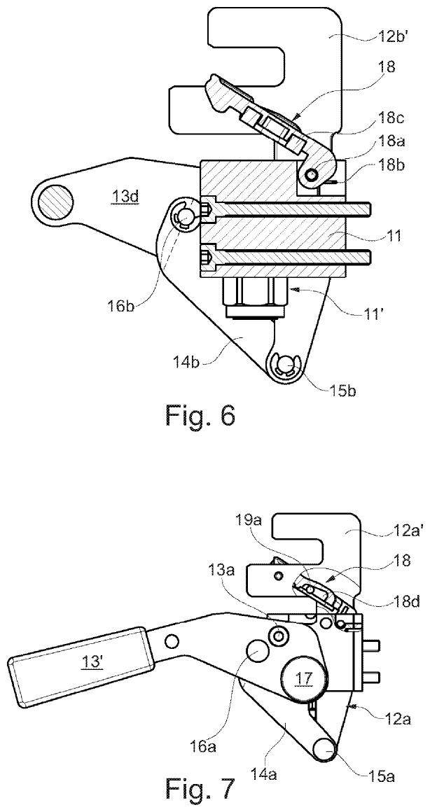

Still with reference to FIG. 3, it can be noted that in the tie-rods 12a, 12b there are plugs 19a, 19b, preferably cylindrical, projecting from said tie-rods towards the inside of the multi-connection device 100 apt to cause the automatic opening movement of the closing lid 18 and on the other hand to keep it in the closed position as will be explained below with reference in particular to the sectional views of FIGS. 6 and 7.

FIG. 4 illustrates a partial section of the multi-connection according to the present invention in side view in which the connecting rods 14a, 14b can be noted in the disconnection position corresponding to the open lever 13.

Advantageously, protrusions 14a′ (and 14b′ not depicted in the figures) are suitably obtained on said connecting rods 14a, 14b in order to abut on the lower part of the fixed plate 11 acting as a stroke stop for the rotary movement of the lever 13.

With particular reference to FIG. 5, it illustrates a further partial section of the multi-connection according to the present invention in the condition of FIG. 4, in which the tie-rods 12a, 12b can be observed which can slide along the substantially vertical direction indicated by the arrows Z in the figure, within an appropriate seat 11a (and 11b not shown in the figures) suitably obtained in said fixed plate 11.

When the lever group 13 is in the “open” position corresponding to a disconnection condition, the connecting rods 14a, 14b push the tie-rods 12a, 12b upwards.

With particular reference to FIG. 6, it can be observed how preferably the lid 18 is hinged to the fixed plate 11 by means of a pin 18a in correspondence of which a torsional spring 18b is advantageously provided, which is prone to keep the lid 18 in closed position.

In addition, a gasket 18c is applied to the lid with the aim of ensuring the closure and to protect the coupling surface of the fixed plate 11.

FIG. 7 illustrates a partial section of the multi-connection according to the present invention in side view that allows to observe how the cylindrical plugs 19a, 19b projecting inwards from said tie-rods 12a, 12b engage in a corresponding shaped seat 18d obtained in the lid 18.

When the rotation of the lever 13 causes, through the connecting rods 14a, 14b, the upward translation of the tie-rods 12a, 12b, the cylindrical plugs 23a, 23b engaged in the shaped seat 18d cause the lid 18 to be lifted and opened.

Conversely, when the lever 13 is not lifted, the lid 18 remains in its closed position resting on the cylindrical plugs 23a, 23b pushed by the torsional spring 18b.

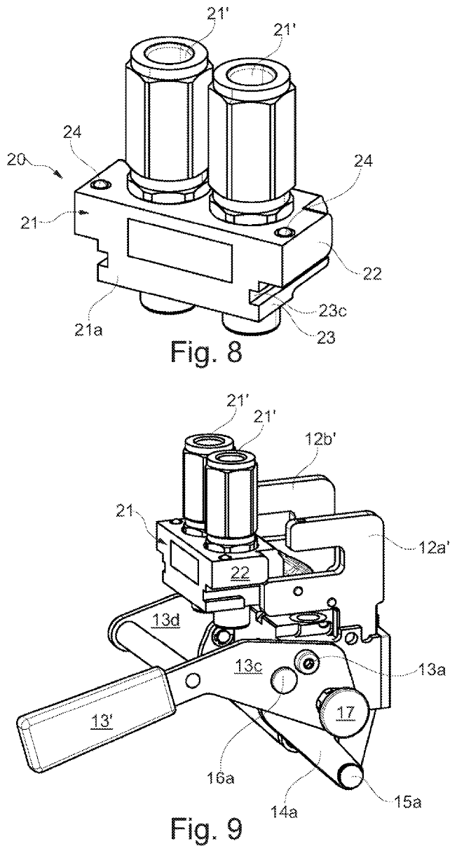

FIG. 8 illustrates the movable part 20 of the multi-connection device with frontal connection 100 according to the present invention.

It preferably comprises a movable plate 21 supporting a plurality of male couplings 21′ for the connection with the corresponding female couplings 11′ that equip said fixed plate 11.

Said movable plate further comprises one or more, advantageously two, spherical pushers 24 for the reciprocal positioning of the upper movable plate 21 with respect to the lower fixed plate 11, which will comprise suitable receiving seats for said pushers.

FIG. 9 illustrates a subsequent connection step in which the operator can bring the movable part 20 closer to the fixed part 10 by inserting the movable plate 21 between the tie-rods 12a, 12b of the fixed part taking care to align the protrusions 22 of the movable plate with the relative C-shaped portions 12a′, 12b′.

Advantageously, the lower face of said protrusions 22 rests on the upper edge of the lower arms 12a″, 12b″ of said shaped portions and slides on them in a frontal inserting movement of the movable plate 21 within the seats of said tie-rods 12a, 12b, while the upper face of said protrusions 22 contacts the lower portion of the upper arms 12a″, 12b″′. The inserting movement can continue until the protrusions 22 abut the substantially vertical surface of said connecting element 12a″″, 12b″″.

The lateral grooves 23c obtained on the lateral faces 23 of said movable plate 21 are apt to receive the cylindrical plugs 23a, 23b, as will be better seen with reference to Figures from 10 to 14.

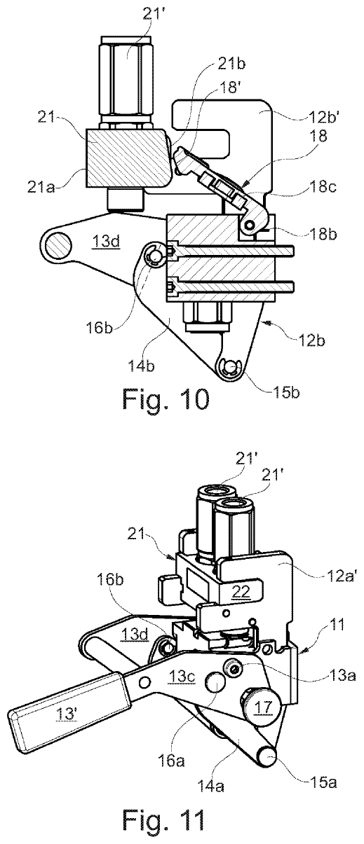

In fact, in FIG. 10 a section of the multi-connection according to the present invention is illustrated with a vertical plane in which it is possible to note that the back surface 21b of the movable plate 21, opposite to the frontal surface 21a, is advantageously suitably shaped, preferably inclined with respect to the vertical direction, to contact the frontal edge 18′ of the closing lid 18 so that the pushing of the movable plate 21 towards the bottom of the C-shaped grooves 12a′, 12b′ of the tie-rods causes the complete opening of the lid 18.

FIG. 11 illustrates the subsequent connection step in which the movable plate 21 is completely inserted into the shaped grooves 12a′, 12b′ obtained in the tie-rods.

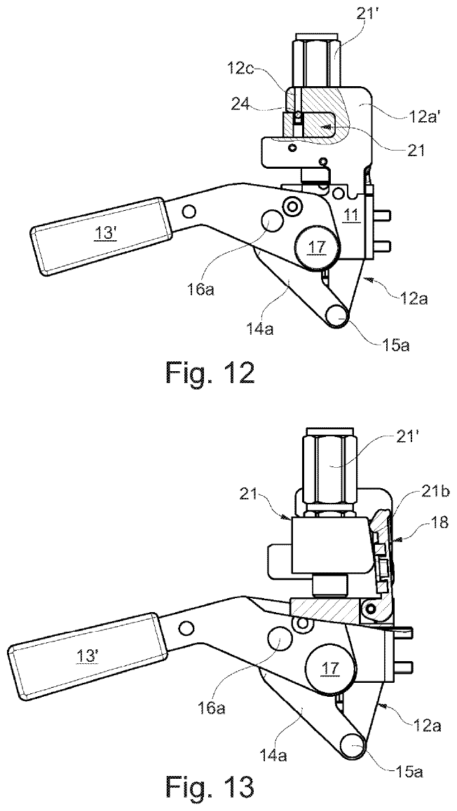

With reference to FIG. 12, it illustrates a partial section in which it can be noted that the movable plate 21 is held in position by said spherical pushers 24 which each find an abutment in a corresponding hole 12c provided in correspondence of the tie-rods, in particular in correspondence of the lower surface of the upper arm 12a″′, 12b″′.

The centring between the pushers 24 and the hole 12c of the tie-rods 12a, 12b guarantees the correct alignment of the male couplings 21′ with the respective female couplings 11′, thus guaranteeing the possibility of connecting hydraulic lines.

FIG. 13 shows a section of the multi-connection device 100 according to the present invention always in the same coupling step between the movable part 20 and the fixed part 10 in which it can be noted how the back profile 21b of the movable plate 21 has pushed the lid 18 into the position of complete opening.

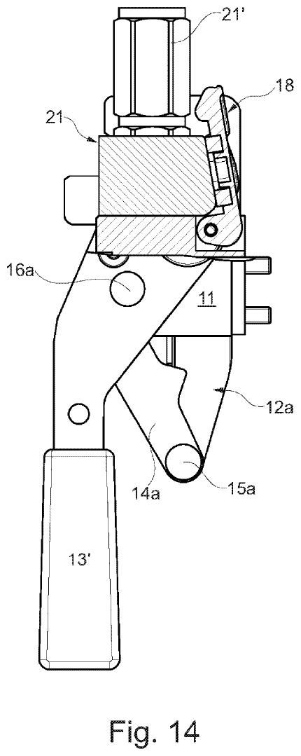

At this point the operator can act on the lever 13′ to make the connection. The rotation of the lever group 13 involves the displacement of the connecting rods 14a, 14b which in turn cause the downward translation of the tie-rods 12a, 12b. The movable part 20 is therefore connected to the fixed part 10 as shown in FIG. 14.

The lock 17 locks the lever group 13 in the “closed” position and, as visible in FIG. 14, the two coupled plates 11, 21 in which it can be noted that the lid 18 rests on the back surface 21b, preferably inclined, of the movable plate 21.

The gasket 18c also rests on the surface of the movable plate 21 which in this way remains protected from any external agents connected to the device.

With regard to disconnection operations, it is firstly necessary to unlock the lock 17, then it is necessary to disconnect the lines by leading the lever group 13 to the “open” position and, subsequently, remove the movable plate 21 by extracting it from the C-shaped grooves of the tie-rods.

It is then possible to rotate the lever 13 leading it back to the “closed” position.

The sequence is the reverse of the illustrated connection sequence.

Advantageously, when the fixed plate is disconnected the cylindrical plugs 23a and 23b assembled in the tie-rods and facing inwards of the multi-connection, push the lid 18 helped by the action of the coil spring 18b, keeping it in the closed position and compressing the gasket 18c, thus ensuring the seal against dirt as illustrated in FIG. 2.

It has thus been shown how a compact frontal connection plate device for the simultaneous connection of a plurality of hydraulic lines and/or electrical connectors according to the present invention achieves the intended task and purposes.

In particular, it has been shown how the compact frontal connection plate device for the simultaneous connection of a plurality of hydraulic lines and/or electrical connectors according to the present invention, in particular thanks to the plate movement system by means of kinematics comprising the connecting rods and the tie-rods, has more compact dimensions than a multi-plate connection device of known type.

In addition, it has been shown how the compact frontal connection plate device for the simultaneous connection of a plurality of hydraulic lines and/or electrical connectors according to the present invention allows to integrate a covering and protection lid of the fixed plate directly in the fixed part of the device and with automatic opening.

The present invention has been described by way of a non-limiting illustrative example according to preferred embodiments thereof, however, it is understood that variations and/or modifications may be made by those skilled in the art, without thereby departing from the relative scope of protection, as defined in the accompanying claims.

The invention claimed is:

1. A frontal connection plate device (100) for a simultaneous connection of a plurality of hydraulic lines and/or electrical connectors, comprising:
a fixed part (10); and
a movable part (20),
wherein said fixed part (10) comprises a fixed plate (11), within which female quick couplings (11′) and/or female electrical connectors are housed, a connecting lever group (13), and at least one pair of vertical tie-rods (12a, 12b) associated vertically in a slidable manner to said fixed plate (11) and moved by said lever group (13) with connecting rods (14a, 14b) linked thereto,
wherein, above said fixed plate (11), said tie-rods (12a, 12b) comprise each a C-shaped portion (12a′, 12b′) configured to slidably receive a movable plate (21) of said movable part (20) supporting male quick couplings (21′) and /or male electrical connectors, and
wherein a movement of said lever group (13) between an open position and a closed position causes, with said connecting rods (14a, 14b), a vertical movement of said tie-rods (12a, 12b) which causes the a clamping of said movable plate (21) on said fixed plate (11) and brings said quick couplings (11′, 21′) and/or electrical connectors from a disconnected condition corresponding to said open position of said lever group (13) to a connected condition corresponding to said closed lever position of said lever group (13).

2. The frontal connection plate device (100) according to claim 1, wherein said lever group (13) in turn comprises a handle (13′) configured to be gripped by an operator for the movement of said lever group (13), and a pair of shaped plates (13c, 13d) hinged on the opposite sides of said fixed plate (11) at a pair of first coaxial pins (13a, 13b).

3. The frontal connection plate device (100) according to claim 2, wherein each of said connecting rods (14a, 14b) is pivoted to one of said vertical tie-rods (12a, 12b) at a second hinge pin (15a, 15b), and to one of said shaped plates (13c, 13d) at a third hinge pin (16a, 16b), so that the movement of the lever group (13) in the open position causes an upward translation of the tie-rods (12a, 12b), which are pushed by said connecting rods (14a, 14b).

4. The frontal connection plate device (100) according to claim 1, wherein each of said tie-rods (12a, 12b) comprises a C-shaped portion (12a′, 12b′) formed by a lower arm (12a″, 12b″), an upper arm (12a″′, 12b″′), and a substantially vertical connecting element (12a″″, 12b″″) configured to act as stroke end for an inserting movement of said movable plate (21) within said C-shaped portions (12a′, 12b′), and wherein said C-shaped portion (12a′, 12b′) of said tie-rods (12a, 12b) is placed above said fixed plate (11).

5. The frontal connection plate device (100) according to claim 4, wherein said movable plate (21) comprises a pair of protrusions (22) projecting sideways and each configured to fit in one of said C-shaped portions (12a′, 12b′) of said tie-rods (12a, 12b).

6. The frontal connection plate device (100) according to claim 5, wherein, when the movable plate (21) is inserted in said C-shaped portions (12a′, 12b′) of said tie-rods (12a, 12b), the a lower face of said protrusions (22) slidably rests on an upper edge of the lower arms (12a″, 12b″) of said C-shaped portions (12a′, 12b′) in a frontal inserting movement of the movable plate (21) within the seats of said tie-rods (12a, 12b), and wherein an upper face of said protrusions (22) contacts a lower portion of the upper arms (12a″′, 12b″′), said inserting movement being stopped by an abutment between said protrusions (22) and the substantially vertical surfaces of the substantially vertical connecting element (12a″″, 12b″″), which connects said lower arms (12a″, 12b″) to said upper arms (12a″′, 12b″′).

7. The frontal connection plate device (100) according to one claim 1, further comprising:
a closing lid (18) configured to cover an upper surface of the fixed plate (11) from which the female couplings (11′) raise, protecting it said upper surface from dirt and dust, and
a pair of plugs (19a, 19b) projecting from said tie-rods (12a, 12b) towards an internal part of the a multi-connection and configured to cause the an automatic opening movement of the closing lid (18) when said lever group (13) is led to the open position, and to keep said closing lid in a closed position with cylindrical plugs (23a, 23b), when said lever group (13) is led to the closed position while the frontal connection plate device (100) is uncoupled.

8. The frontal connection plate device (100) according to claim 7, wherein said closing lid (18) comprises at least a shaped seat (18d) defined at least at a lateral surface of said closing lid (18) and configured to receive a corresponding one of said pair of plugs (19a, 19b) projecting from said tie-rods (12a, 12b).

9. The frontal connection plate device (100) according to claim 8, wherein said closing lid (18) is hinged to said fixed plate (11) with a pin (18a) in correspondence of which a torsional spring (18b) is provided and is configured closing lid (18) in the closed position.

10. The frontal connection plate device (100) according to claim 9, wherein said closing lid (18) further comprises a gasket (18c) configured to ensure a seal and to protect an upper surface of said fixed plate (11).

11. The frontal connection plate device (100) according to claim 7, wherein said movable plate (21) comprises a shaped back surface (21b) configured to contact a frontal edge (18′) of the closing lid (18), so that a translational movement of said movable plate (21) towards the a bottom of the C-shaped portions (12a′, 12b′) of the tie-rods causes the a complete opening of the closing lid (18).

12. The frontal connection plate device (100) according to claim 6, further comprising, at an upper surface of said movable plate (21), a pair of spherical pushers (24) and, on a lower surface of said upper arm (12a″′, 12b″′) of said C-shaped portions (12a′, 12b′) of said tie-rods (12a, 12b), corresponding holes (12c).
